(19) United States
(12) Patent Application Publication
(10) Pub. No.: US 2016/0086107 A1
(43) Pub. Date: Mar. 24, 2016

(54) METHODS FOR CALCULATING A TOTAL KNOWLEDGE EXPLOITATION SCORE FOR A KNOWLEDGE ARTIFACT AND DEVICES THEREOF

(71) Applicant: Wipro Limited, Bangalore (IN)

(72) Inventors: Sreenivas Kunapuli, Hyderabad (IN); Anuradha Pentareddy, Hyderabad (IN)

(21) Appl. No.: 14/539,559

(22) Filed: Nov. 12, 2014

(30) Foreign Application Priority Data
Sep. 22, 2014 (IN) 4587/CHE/2014

(51) Int. Cl. G06Q 10/06

(52) U.S. Cl. CPC G06Q 10/063

(57) ABSTRACT

A method, non-transitory computer readable medium and device that calculates a total knowledge exploitation score for a knowledge artifact in a knowledge management system which comprises determining at the knowledge management data server device, a strategic positioning index for a knowledge artifact based on at least one of a market attractiveness index or a competitive position index. A financial positioning index for the knowledge artifact based on a conversational economic potential score is determined at the knowledge management data server device. Next a resource usage index for the knowledge artifact is determined based on at least one of an internal usage score or an external usage score. A total knowledge exploitation score for the knowledge artifact is then finally determined based on at least the calculated strategic positioning index, the determined financial positioning index and the determined resource usage index for the knowledge artifact in the knowledge management system.

This application claims the benefit of Indian Patent Application Serial No. 4587/CHE/2014 filed Sep. 22, 2014, which is hereby incorporated by reference in its entirety.

### FIELD

This disclosure generally relates to methods and devices for assessing the efficacy and maturity of a knowledge artifact in a knowledge management system and, more specifically, to a method for calculating a total knowledge exploitation score for a knowledge artifact in a knowledge management system and devices thereof.

### BACKGROUND

Remarkable advancements have been achieved in the knowledge management domain in recent times. Most organizations have a Knowledge Management System and in most of these organizations, they focus on the efficient management of Knowledge artifacts in their organization.

The current existing Knowledge Management systems do not have or know how to implement mechanisms for exploiting conversations relating to a knowledge artifact during its lifecycle on a Knowledge Hub to provide improved Knowledge Management. As a result, this inhibits organizations from using the full potential of their knowledge artifacts. For example, these organizations are missing out on new business ideas and opportunities with high commercial value because of this inability to recognize the usefulness of these conversations relating to a knowledge artifact. For organizations to be successful in this increasing completive marketplace, this failure to fully utilize their knowledge artifacts is detrimental to the experience of their customers.

Accordingly, as discussed above existing knowledge management systems do not address the above mentioned drawbacks. Thus, there is a need for an improved knowledge management system which performs knowledge exploitation in an efficient manner and addresses the above mentioned drawbacks.

### SUMMARY

A method for calculating a total knowledge exploitation score for a knowledge artifact in a knowledge management system comprises determining, at the knowledge management data server device, a strategic positioning index for a knowledge artifact based on at least one of a market attractiveness index or a competitive position index for the knowledge artifact. Subsequently, a financial positioning index for the knowledge artifact based on a conversational economic potential score for the knowledge artifact is determined at the knowledge management data server device. Next a resource usage index for the knowledge artifact is determined based on at least one of an internal usage score or an external usage score. A total knowledge exploitation score for the knowledge artifact is then finally determined based on at least the calculated strategic positioning index, the determined financial positioning index and the determined resource usage index for the knowledge artifact in the knowledge management system.

A non-transitory computer readable medium having stored thereon instructions for calculating a total knowledge exploitation score for a knowledge artifact in a knowledge management system, comprising machine executable code which when executed by a processor, causes the processor to perform steps comprising, determining at the knowledge management data server device, a strategic positioning index for a knowledge artifact based on at least one of a market attractiveness index or a competitive position index for the knowledge artifact. Subsequently, a financial positioning index for the knowledge artifact based on a conversational economic potential score for the knowledge artifact is determined at the knowledge management data server device. Next a resource usage index for the knowledge artifact is determined based on at least one of an internal usage score or an external usage score. A total knowledge exploitation score for the knowledge artifact is then finally determined based on at least the calculated strategic positioning index, the determined financial positioning index and the determined resource usage index for the knowledge artifact in the knowledge management system.

A knowledge management computing device, comprising a memory and a processor coupled to the memory and configured to execute programmed instructions stored in the memory comprising, determining at the knowledge management data server device, a strategic positioning index for a knowledge artifact based on at least one of a market attractiveness index or a competitive position index for the knowledge artifact. Subsequently, a financial positioning index for the knowledge artifact based on a conversational economic potential score for the knowledge artifact is determined at the knowledge management data server device. Next a resource usage index for the knowledge artifact is determined based on at least one of an internal usage score or an external usage score. A total knowledge exploitation score for the knowledge artifact is then finally determined based on at least the calculated strategic positioning index, the determined financial positioning index and the determined resource usage index for the knowledge artifact in the knowledge management system.

It is to be understood that both the foregoing general description and the following detailed description are exemplary and explanatory only and are not restrictive of the invention, as claimed.

### BRIEF DESCRIPTION OF THE DRAWINGS

FIG. 1 is a block diagram of an exemplary environment with an example of a knowledge management computing device configured to calculate a total knowledge exploitation score for a knowledge artifact in the knowledge management system;

FIG. 2 is a block diagram of the exemplary knowledge management computing device illustrated in FIG. 1;

FIG. 3 is a flow chart of an example of a method for calculating total knowledge exploitation score for a knowledge artifact in a knowledge management system in accordance with some embodiments; and

FIG. 4 is an exemplary embodiment of a typical finance model for business ventures.

### DETAILED DESCRIPTION

Now, exemplary embodiments of the present disclosure will be described with reference to the accompanying drawings. Wherever possible, the same reference numbers will be used throughout the drawings to refer to the same or like parts. While exemplary embodiments and features are described herein, modifications, adaptations, and other implementations are possible, without departing from the spirit and scope of the disclosure. Accordingly, the following detailed description does not limit the subject matter. Instead, the proper scope of the subject matter is defined by the appended claims.

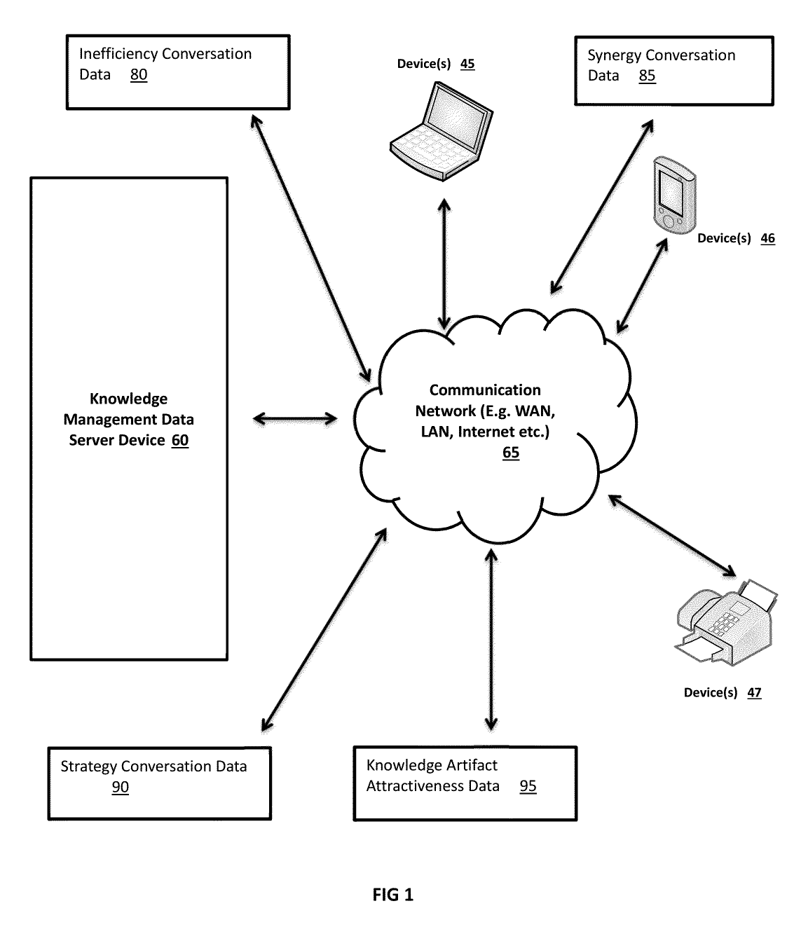

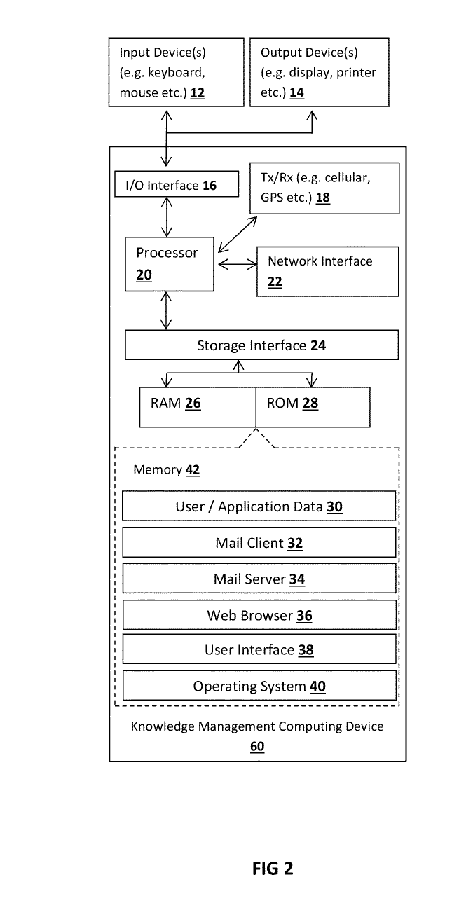

FIG. 1 is a diagram of an exemplary environment with a knowledge management computing device 60 configured to calculate the total knowledge exploitation score for a knowledge artifact in a knowledge management system. The knowledge management computing device is one of the possible variations of the knowledge management computing device 60 described in greater detail below with reference to FIG. 2. The example of an environment described here in FIG. 1 includes the knowledge management computing device 60 being connected to the communication network 65 in a variation of some of the mentioned methods described in greater detail herein. The knowledge management computing device 60 is further connected to multiple knowledge artifact and system level data sources like the inefficiency conversation data source 80, synergy conversation data source 85, knowledge artifact attractiveness data source 95, strategy conversation data source 90 received by the knowledge management system itself, through the communication network 65, although the knowledge management computing device 60 could be connected to other types and/or numbers of sources. The knowledge management computing device 60 then receives through the communication network 65, data regarding the various aspects of the knowledge artifacts, customer-customer interaction experience and artifact-customer interaction experience by way of example only from one or more of the above mentioned multiple data sources upon which the strategic positioning index, the financial positioning index and resource usage index are determined. This data is further analyzed by the knowledge management computing device 60 and a total knowledge exploitation score for the knowledge artifact in the knowledge management system is calculated, which is based on the determined strategic positioning index of the knowledge artifact, the determined financial positioning index and the determined resource usage index for the knowledge artifact in the knowledge management system.

FIG. 2 is a block diagram of an example of the knowledge management computing device 60 configured to calculate the total knowledge exploitation score for a knowledge artifact in a knowledge management system, although other types and/or numbers of other computer devices or other systems could be used as a knowledge management computing device. Knowledge management computing device 60 may comprise a central processing unit (“CPU” or “processor”) 20. Processor 20 may comprise at least one data processor for executing program components for executing user or system-generated requests. A user may include a person, a person using a device, such as such as those included in this disclosure, or such a device itself. The processor 20 may include specialized processing units such as integrated system (bus) controllers, memory management control units, floating point units, graphics processing units, digital signal processing units, by way of example only. The processor 20 may include a microprocessor, such as AMD Athlon, Duron or Opteron, ARM's application, embedded or secure processors, IBM PowerPC, Intel's Core, Itanium, Xeon, Celeron or other line of processors, by way of example only. The processor 20 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), by way of example only.

Processor 20 may be disposed in communication with one or more input/output (I/O) devices via I/O interface 16. The I/O interface 16 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), by way of example only.

Using the I/O interface 16, the knowledge management computing device 60 may communicate with one or more I/O devices. For example, the input device 12 may be an antenna, keyboard, mouse, joystick, (infrared) remote control, camera, charge-coupled device (CCD), card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, by way of example only. Output device 14 may be a printer, fax machine, video display (e.g., cathode ray tube (CRT), liquid crystal display (LCD), light-emitting diode (LED), plasma, or the like), audio speaker, by way of example only. In some embodiments, a transceiver 18 may be disposed in connection with the processor 20. The transceiver 18 may facilitate various types of wireless transmission or reception. For example, the transceiver 18 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, by way of example only.

In some embodiments, the processor 20 may be disposed in communication with a communication network via a network interface 22. The network interface 22 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, by way of example only. The communication network may include, without limitation, a direct interconnection, local area network (LAN), wide area network (WAN), wireless network (e.g., using Wireless Application Protocol), the Internet, by way of example only. Using the network interface 22 and the communication network, the knowledge management computing device 60 may communicate with one or more devices 45, 46, and 47 (as depicted in FIG. 1) although other types and/or numbers of other devices and/or systems could be connected. These devices may include, without limitation, personal computer(s), server(s), fax machines, printers, scanners, various mobile devices such as cellular telephones, smartphones (e.g., Apple iPhone, Blackberry, Android-based phones, by way of example only.), tablet computers, eBook readers (Amazon Kindle, Nook, by way of example only.), laptop computers, notebooks, gaming consoles (Microsoft Xbox, Nintendo DS, Sony PlayStation, by way of example only.), or the like. In some embodiments, the knowledge management computing device 60 may itself embody one or more of these devices.

In some embodiments, the processor 20 may be disposed in communication with one or more memory devices (e.g., RAM 26, ROM 28, by way of example only.) via a storage interface 24. The storage interface 24 may connect to memory devices including, without limitation, memory drives, removable disc drives, by way of example only, employing connection protocols such as serial advanced technology attachment (SATA), integrated drive electronics (IDE), IEEE-1394, universal serial bus (USB), fiber channel, small computer systems interface (SCSI), by way of example only. The memory drives may further include a drum, magnetic disc drive, magneto-optical drive, optical drive, redundant array of independent discs (RAID), solid-state memory devices, solid-state drives, by way of example only.

The memory devices comprise a memory 42 that may store a collection of program, database components, and/or other data including, by way of example only and without limitation, an operating system 40, user interface application 38, web browser 36, mail server 34, mail client 32, user/application data 30 (e.g., any data variables or data records discussed in this disclosure), although other types and/or numbers of other programmed instructions, modules, and/or other data may be stored The operating system 40 may facilitate resource management and operation of the knowledge management computing device 60. Examples of operating systems include, without limitation, Apple Macintosh OS X, Unix, Unix-like system distributions (e.g., Berkeley Software Distribution (BSD), FreeBSD, NetBSD, OpenBSD, by way of example only.), Linux distributions (e.g., Red Hat, Ubuntu, Kubuntu, by way of example only.), IBM OS/2, Microsoft Windows (XP, Vista/7/8, by way of example only.), Apple iOS, Google Android, Blackberry OS, or the like. User interface 38 may facilitate display, execution, interaction, manipulation, or operation of program components through textual or graphical facilities. For example, user interfaces may provide computer interaction interface elements on a display system operatively connected to the knowledge management computing device 60, such as cursors, icons, check boxes, menus, scrollers, windows, widgets, by way of example only. Graphical user interfaces (GUIs) may be employed, including, without limitation, Apple Macintosh operating systems' Aqua, IBM OS/2, Microsoft Windows (e.g., Aero, Metro, by way of example only.), Unix X-Windows, web interface libraries (e.g., ActiveX, Java, Javascript, AJAX, HTML, Adobe Flash, by way of example only.), or the like.

In some embodiments, the knowledge management computing device 60 may implement a web browser 36 stored program component. The web browser 36 may be a hypertext viewing application, such as Microsoft Internet Explorer, Google Chrome, Mozilla Firefox, Apple Safari, by way of example only. Secure web browsing may be provided using HTTPS (secure hypertext transport protocol), secure sockets layer (SSL), Transport Layer Security (TLS), by way of example only. Web browser 36 may utilize facilities, such as AJAX, DHTML, Adobe Flash, JavaScript, Java, application programming interfaces (APIs), by way of example only. In some embodiments, the knowledge management computing device 60 may implement a mail server 34 stored program component. The mail server may be an Internet mail server, such as Microsoft Exchange, although other types and/or numbers of mail server systems may be used. The mail server may utilize facilities such as ASP, ActiveX, ANSI C++/C#, Microsoft .NET, CGI scripts, Java, JavaScript, PERL, PHP, Python, WebObjects, by way of example only. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the knowledge management computing device 60 may implement a mail client 32 stored program component. The mail client 32 may be a mail viewing application, such as Apple Mail, Microsoft Entourage, Microsoft Outlook, Mozilla Thunderbird, by way of example only.

In some embodiments, knowledge management computing device 60 may store user/application data 30, such as the data, variables, records, by way of example only as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, by way of example only.). Such databases may be consolidated or distributed, sometimes among the various computer systems discussed above in this disclosure. It is to be understood that the structure and operation of the any computer or database component may be combined, consolidated, or distributed in any working combination.

An exemplary method for calculating total knowledge exploitation score for a knowledge artifact in a knowledge management system will now be described with reference to FIGS. 1-4. The exemplary method comprises calculating a strategic positioning index, a financial positioning index and a resource usage index for the knowledge artifact in a knowledge management system by the knowledge management computing device 60, based on a market attractiveness index, a competitive position index, a conversational economic potential score, an internal usage score and an external usage score for the knowledge artifact in the knowledge management system. The exemplary method further comprises calculating a total knowledge exploitation score for the knowledge artifact in the knowledge management system, based on the calculated strategic positioning index, a financial positioning index and resource usage index.

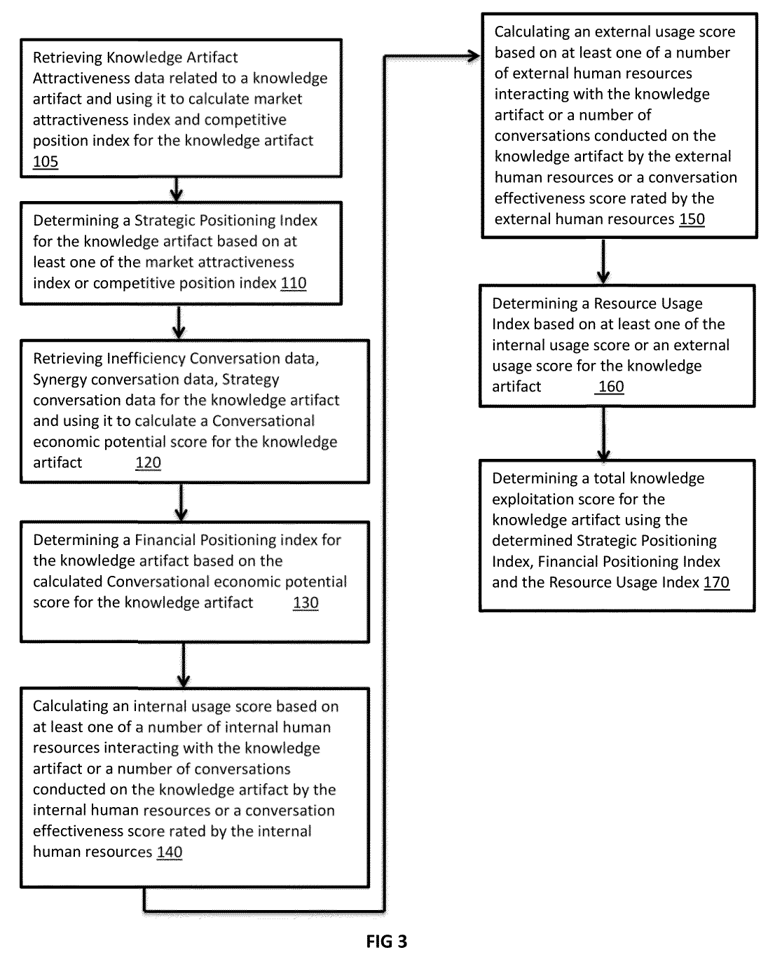

The exemplary method begins at step 105 of FIG. 3 where the knowledge management computing device 60 receives a knowledge artifact attractiveness data related to a knowledge artifact present in the knowledge management system. A user, who can be either an employee or supplier or customer can access and interact with the knowledge management computing device 60 or with other similar users, through standard communication network 65 like the internet, telecommunication lines using a web portal or a typical stand-alone application that is housed within the company premises and having access to the company's internal data and applications. In some embodiments, the knowledge management computing device 60 may store data like a database or have access to the stored data in a separate database which includes but not restricted to inefficiency conversation data, synergy conversation data, strategy conversation data and knowledge artifact attractiveness data. The knowledge management computing device 60 will also act as a database storing the results of all the data transformation and score calculations towards the various parameters leading to the total knowledge exploitation score of the knowledge artifact in the knowledge management system.

As an example, there can be multiple users interacting with each other while using varied modes of communication, on the knowledge management portal discussing about the knowledge artifact. The knowledge management system houses a plurality of knowledge artifacts that are uploaded or saved in the knowledge management system by users like employees, vendors or suppliers. The multiple user conversations that indicate market attractiveness of the knowledge artifact and the competitive positioning that the content of the knowledge artifact can create in the market defines how the organization can position their product offerings of the knowledge artifact in a more optimum and strategic manner. An index to measure such a strategic position of a knowledge artifact in this example is termed as a Strategic Positioning Index. The Strategic Positioning Index is calculated based on two other indices, Market Attractiveness Index and Competition Position Index, although other types and/or other numbers of indexes or other data could be used in this calculation.

Market Attractiveness Index deals with how the knowledge artifact is influencing the market and its need in the market through conversations that happen on the Knowledge artifact between various users. Using standard semantic analyzers to interpret the conversation text and context along with a standard rules engine and prior set rules, the attractiveness of the knowledge artifact is measured and graded by the knowledge management computing device 60, based on its perceived impact on the market by the users. This is carried out, by way of an example, through both the analysis of the user conversation interactions and surveys that are rolled out to the users which take the users inputs and ratings on the market impact of the knowledge artifact. A value of conversation attractiveness index, Ai, is calculated based on the semantic analysis of the user conversations which, by way of examples, can be provided values of 1, 5 or 10. If the analysis of the user conversations on the knowledge artifact proves a low level of market impact by the knowledge artifact as perceived by the users, then a value of 1 is provided to Ai to symbolize low attractive index levels. Similarly, if the analysis of the user conversations on the knowledge artifact proves a moderate or medium level of market impact by the knowledge artifact as perceived by the users, then a value of 5 is provided to Ai to symbolize medium attractive index levels. Finally, if the analysis of the user conversations on the knowledge artifact proves a very high level of market impact and correlation by the knowledge artifact as perceived by the users, then a value of 10 is provided to Ai to symbolize high attractive index levels. A similar grading system is deployed, by way of an example, for the attractiveness index as derived from the surveys, termed the survey attractiveness index Si, and is rated with values of 1, 5 or 10 symbolizing low, medium and high levels of attractive index for the knowledge artifact derived from surveys provided to users. Subsequently, the knowledge management computing device 60, calculates the Market Attractiveness Index (MAI) based on the calculated conversation attractiveness index, Ai and the survey attractiveness index, Si as described by the equation

MAI for a knowledge artifact=Si*(Ai*(N*(N−1)/2))

where N is the number of conversations conducted on the knowledge management portal concerning the knowledge artifact, although other types and/or other numbers of indexes or other data could be used in this calculation.

Competition Position Index (CPI) is determined based on how the knowledge artifact is creating impact in the market and creating competing business through conversations that happen on the Knowledge artifact. Surveys are rolled out onto the knowledge portal management system by the knowledge management computing device 60 to the various users who are part of such conversations to record their inputs and ratings on the CPI. A standard grading system is deployed, by way of an example, for the competition position index as derived from the surveys, termed CPI, and is rated with values of 1, 5 or 10 symbolizing low, medium and high levels of competitive positioning in creating competing business, for the knowledge artifact derived from surveys provided to users. Subsequently the knowledge management computing device 60, calculates the Strategic Positioning Index (SPI), as described in step 110 of FIG. 1, based on the above calculated MAI and CPI, as described by the equation

SPI for a knowledge artifact=MAI*CPI

although other types and/or other numbers of indexes or other data could be used in this calculation.

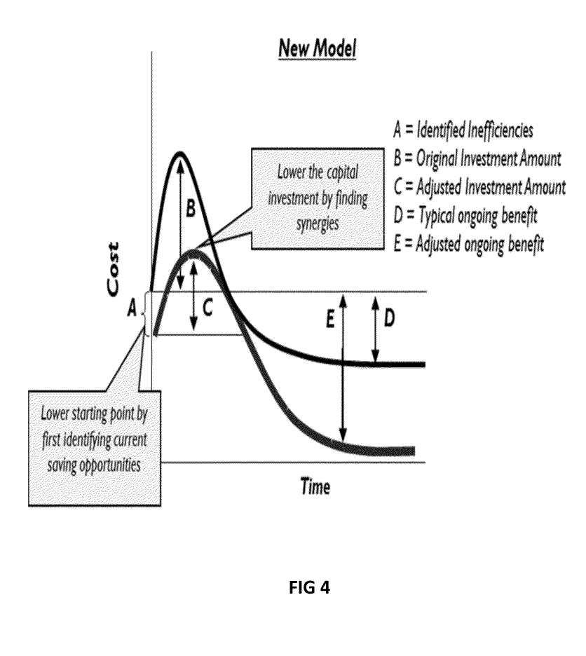

At the next step 120 of FIG. 3, the knowledge management computing device 60, analyses user interactions and conversations conducted on the knowledge management portal about a knowledge artifact to retrieve an inefficiency conversation data, synergy conversation data and strategy conversation data. This type of analyses on user interactions or conversations on the knowledge management portal about the knowledge artifact is carried out by the knowledge management computing device 60, by using a standard semantic analyzer and pre-set rules stored in memory 42 in this example. The inefficiency conversation data, synergy conversation data and strategy conversation data are all determined using a typical finance model system for business ventures as described and illustrated in the example in FIG. 4. By way of an example, the inefficiency conversation data is determined based on the number of conversations that involve a changing of the starting point in a business venture by identifying hidden inefficiencies in the system. This would involve modification of current processes to make a permanent change in the system and is represented by ‘A’ in the FIG. 4. Similarly, the synergy conversation data is determined based on the number of conversations that involve a sequencing of necessary investments to achieve synergies. This is represented by ‘(B−C)’ in the FIG. 4 where ‘(B−C)’ refers to the difference between the original invested amount and the adjusted invested amount due to change of starting point. Finally, the strategy conversation data is determined based on the number of conversations that involve deployment of strategy programs that include ‘sunset plans’ or retirement plans for existing legacy systems in the business venture. This is represented by ‘(E−D)’ in the FIG. 4 where ‘(E−D)’ refers to the difference between the adjusted ongoing benefit due to change of starting point and the typical ongoing benefit. The strategy conversation data helps in understanding the difference between desired capabilities in the business venture and existing capabilities and helps in evaluating need for legacy systems based on cost benefits. As an example, based on the above determined inefficiency conversation data, synergy conversation data and strategy conversation data, the knowledge management computing device 60, then calculates the conversational economic potential score for the knowledge artifact as described in step 120 in FIG. 3 and by the equation provided below,

Conversational Economic Potential Score of Knowledge Artifact=A+(B−C)+(E−D)

although other approaches for calculating this score could be used.

Finally, the knowledge management computing device 60, determines the Financial Positioning Index (FPI) based on the conversational economic potential score of the knowledge artifact as described in step 130 of FIG. 3 and by the equation provided below,

FPI=(conversational economic potential score of knowledge artifact)*N

where N refers to the number of conversations that have occurred on the knowledge artifact, although other approaches for calculating this score could be used.

At the next step 140 as described in FIG. 3, the knowledge management computing device 60, determines an internal usage score (IUS) derived from the conversations that occur on a knowledge artifact, using a standard semantic analyzer and pre-set rules stored in memory 42 in this example, which comprises three parameters IR, IC and IE in this example, although other types and/or numbers of parameters or other factors could be used. First IR is defined as the number of internal human resources involved with a knowledge artifact. Next IC is defined as the number of conversations that occur on the knowledge artifact due to the internal human resources. Finally IE is defined as the perceived effectiveness of the conversation that occurs on the knowledge artifact by the internal human resources. As an example, IE is determined by using surveys provided to the internal human resources to identify the effectiveness of the conversation using varied levels of low effectiveness, medium effectiveness and high effectiveness which can correspond to a value of 1, 5 and 10 respectively. The knowledge management computing device 60, then calculates the internal usage score (IUS) as described in the following equation,

IUS=((IR*IR−1)/2*IC*IE)

although other approaches for calculating this score could be used.

At the next step 150 as described in FIG. 3, the knowledge management computing device 60, determines an external usage score (EUS) derived from the conversations that occur on a knowledge artifact, using a standard semantic analyzer and pre-set rules stored in memory 42 in this example, which comprises of three parameters ER, EC and EE in this example, although other types and/or numbers of parameters or other factors could be used. First ER is defined as the number of external human resources involved with a knowledge artifact. Next EC is defined as the number of conversations that occur on the knowledge artifact due to the external human resources. Finally EE is defined as the perceived effectiveness of the conversation that occurs on the knowledge artifact by the external human resources. As an example, EE is determined by using surveys provided to the external human resources to identify the effectiveness of the conversation using varied levels of low effectiveness, medium effectiveness and high effectiveness which can correspond to a value of 1, 5 and 10 respectively. The knowledge management computing device 60, then calculates the external usage score (EUS) as described in the following equation.

EUS=((ER*ER−1)/2*EC*EE)

although other approaches for calculating this score could be used.

Now, the knowledge management computing device 60, determines a Resource Usage Index (RUI) as described in step 160 of FIG. 3, based on the calculated internal usage score (IUS) and the external usage score (EUS). The determination of RUI by the knowledge management computing device 60 is as described in the equation below,

RUI=IUS/EUS

although other approaches for calculating this index could be used.

Post the calculation of the resource usage index (RUI) for the knowledge artifact in a knowledge management system, the knowledge management computing device 60 calculates a total knowledge exploitation score for the knowledge artifact as described in step 170 of FIG. 3, although other approaches for calculating this score could be used. In this example, the total knowledge exploitation score for the knowledge artifact in the knowledge management system is computed by simply multiplying the already calculated strategic positioning index (SPI), financial positioning index (FPI) and the resource usage index (RUI) where a higher total knowledge exploitation score typically indicates a well exploited knowledge artifact from a commercial point of view, in a knowledge management system. The knowledge management computing device 60, calculates the total knowledge exploitation score for the knowledge artifact in the knowledge management system as described in the equation below,

Total Knowledge Exploitation Score of a Knowledge Artifact=SPI*FPI*RUI

although other approaches for calculating this score could be used.

As an example, the FPI can attain an overall value of 0 or zero while both SPI and RUI will be non-zero and have a minimum positive value definitely. In this scenario, the total knowledge exploitation score can become zero also, indicating that even if the knowledge artifact has a valid strategy and resource usage, if there is no financial viability, the exploitation of a knowledge artifact is considered null.

The specification has described an example of a method and device for calculating a total knowledge exploitation score for a knowledge artifact in a knowledge management system. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, and/or deviations, by way of example only, of those described herein) will be apparent to persons skilled in the relevant art(s) based on the teachings contained herein. Such alternatives fall within the scope and spirit of the disclosed embodiments.

Furthermore, one or more non-transitory computer-readable storage media may be utilized in implementing embodiments consistent with the present disclosure. A non-transitory computer-readable storage medium refers to any type of physical memory on which information or data readable by a processor may be stored. Thus, a non-transitory computer-readable storage medium may store instructions for execution by one or more processors, including programmed instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A method for calculating a total knowledge exploitation score for knowledge artifact in a knowledge management system, the method comprising:
determining, by a knowledge management computing device, a strategic positioning index for a knowledge artifact based on at least one of a market attractiveness index or a competitive position index for the knowledge artifact;
determining, by the knowledge management computing device, a financial positioning index for the knowledge artifact based on a conversational economic potential score for the knowledge artifact;
determining, by the knowledge management computing device, a resource usage index for the knowledge artifact based on at least one of an internal usage score or an external usage score; and
determining, by the knowledge management computing device, a total knowledge exploitation score for the knowledge artifact based on at least the calculated strategic positioning index, the determined financial positioning index and the determined resource usage index for the knowledge artifact in the knowledge management system.

2. The method as set forth in claim 1 further comprising:
retrieving, by the knowledge management computing device, knowledge artifact attractiveness data related to the knowledge artifact; and
determining, by the knowledge management computing device, the market attractiveness index and competitive position index of the knowledge artifact based on the retrieved knowledge artifact attractiveness data.

3. The method as set forth in claim 1 further comprising:
retrieving, by the knowledge management computing device, inefficiency conversation data, synergy conversation data and strategy conversation data for the knowledge artifact; and
generating, by the knowledge management computing device, the conversational economic potential score for the knowledge artifact based on at least the retrieved inefficiency conversation data, synergy conversation data and strategy conversation data.

4. The method as set forth in claim 1 wherein the internal usage score is determined based on at least one of a number of internal human resources interacting with the knowledge artifact or a number of conversations conducted on the knowledge artifact by the internal human resources or a conversation effectiveness score rated by the internal human resources.

5. The method as set forth in claim 1 wherein the external usage score is determined based on at least one of a number of external human resources interacting with the knowledge artifact or a number of conversations conducted on the knowledge artifact by the external human resources or a conversation effectiveness score rated by the external human resources.

6. The method as set forth in claim 2 wherein the knowledge artifact attractiveness data is based on at least one of a standard attractiveness index or a standard survey index or the number of conversations conducted on the knowledge artifact or knowledge artifact competitiveness.

7. A knowledge management computing device, comprising:
a memory; and
a processor coupled to the memory and configured to execute programmed instructions stored in the memory, comprising:
determining a strategic positioning index for a knowledge artifact in the knowledge management system, based on at least one of a market attractiveness index or a competitive position index for the knowledge artifact;
determining a financial positioning index for the knowledge artifact in the knowledge management system, based on a conversational economic potential score for the knowledge artifact;
determining a resource usage index for the knowledge artifact in the knowledge management system based on at least an internal usage score and an external usage score; and
determining a total knowledge exploitation score for the knowledge artifact in the knowledge management system based on the calculated strategic positioning index, the determined financial positioning index and the determined resource usage index for the knowledge artifact in the knowledge management system.

8. The device of claim 7, wherein the processor is further configured to execute programmed instructions stored in the memory for the calculating, further comprises:
retrieving knowledge artifact attractiveness data related to the knowledge artifact in the knowledge management system; and
determining the market attractiveness index and competitive position index of the knowledge artifact based on the retrieved knowledge artifact attractiveness data.

9. The device of claim 7, wherein the processor is further configured to execute programmed instructions stored in the memory for the determining, further comprises:
retrieving inefficiency conversation data, synergy conversation data and strategy conversation data for the knowledge artifact in the knowledge management system; and
generating the conversational economic potential score for the knowledge artifact, based on at least the retrieved inefficiency conversation data, synergy conversation data and strategy conversation data.

10. The device of claim 7, wherein the internal usage score is determined based on at least one of a number of internal human resources interacting with the knowledge artifact or a number of conversations conducted on the knowledge artifact by the internal human resources or a conversation effectiveness score rated by the internal human resources.

11. The device of claim 7, wherein the external usage score is determined based on at least one of a number of external human resources interacting with the knowledge artifact or a number of conversations conducted on the knowledge artifact by the external human resources or a conversation effectiveness score rated by the external human resources.

12. The device of claim 8, wherein the knowledge artifact attractiveness data is based on at least one of a standard attractiveness index or a standard survey index or the number of conversations conducted on the knowledge artifact or knowledge artifact competitiveness.

13. A non-transitory computer readable medium having stored thereon instructions for calculating a total knowledge exploitation score for a knowledge artifact in a knowledge management system, comprising machine executable code which when executed by a processor, causes the processor to perform steps comprising:
determining a strategic positioning index for a knowledge artifact based on at least one of a market attractiveness index or a competitive position index for the knowledge artifact;
determining a financial positioning index for the knowledge artifact based on a conversational economic potential score for the knowledge artifact;
determining a resource usage index for the knowledge artifact based on at least an internal usage score and an external usage score; and
determining a total knowledge exploitation score for the knowledge artifact based on at least the calculated strategic positioning index, the determined financial positioning index and the determined resource usage index for the knowledge artifact in the knowledge management system.

14. The medium of claim 13, wherein the processor is further configured to execute programmed instructions stored in the memory for the determining, further comprises:
retrieving knowledge artifact attractiveness data related to the knowledge artifact; and
determining the market attractiveness index and competitive position index of the knowledge artifact based on the retrieved knowledge artifact attractiveness data.

15. The medium of claim 13, wherein the processor is further configured to execute programmed instructions stored in the memory for the determining, further comprises:
retrieving inefficiency conversation data, synergy conversation data and strategy conversation data for the knowledge artifact; and
generating the conversational economic potential score for the knowledge artifact based on at least the retrieved inefficiency conversation data, synergy conversation data and strategy conversation data.

16. The medium of claim 13, wherein the processor is further configured to execute programmed instructions stored in the memory for the determining, wherein the internal usage score is determined based on at least one of a number of internal human resources interacting with the knowledge artifact or a number of conversations conducted on the knowledge artifact by the internal human resources or a conversation effectiveness score rated by the internal human resources.

17. The medium of claim 13, wherein the processor is further configured to execute programmed instructions stored in the memory for the determining, wherein the external usage score is determined based on at least one of a number of external human resources interacting with the knowledge artifact or a number of conversations conducted on the knowledge artifact by the external human resources or a conversation effectiveness score rated by the external human resources.

18. The medium of claim 14, wherein the knowledge artifact attractiveness data is based on at least one of a standard attractiveness index or a standard survey index or the number of conversations conducted on the knowledge artifact or knowledge artifact competitiveness.
